(19) United States
(12) Patent Application Publication
(10) Pub. No.: US 2011/0009305 A1
(43) Pub. Date: Jan. 13, 2011

(54) Layered Particles and Compositions Comprising Same

(76) Inventors: Nigel Patrick Somerville Roberts, Newcastle upon Tyne (GB); Alan Thomas Brooker, Newcastle upon Tyne (GB); David James Parmley, Gateshead (GB); Victor Stuar Reid, Newcastle upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/767,890

(22) Filed: Apr. 27, 2010

Related U.S. Application Data
(60) Provisional application No. 61/224,173, filed on Jul. 9, 2009.

(51) Int. Cl. C01B 15/037; C11D 3/39; C01B 15/01; D06L 3/02

(52) U.S. Cl. 510/318; 510/309; 423/584; 252/186.28; 252/186.29

(57) ABSTRACT

Layered particles that contain a source of hydrogen peroxide, a binder material, and a bleach activator and a method of improving the stability of a source of hydrogen peroxide. The layered particles can be incorporated into granular detergents.

### CROSS REFERENCE TO RELATED APPLICATION

This application claims the benefit of priority to U.S. Provisional Application Ser. No. 61/224,173, filed Jul. 9, 2009.

### FIELD OF THE INVENTION

Layered particles, compositions comprising such particles as well as methods of making and using such particles and compositions, are disclosed. A method of improving the stability of a source of hydrogen peroxide is also disclosed.

### BACKGROUND OF THE INVENTION

Inorganic peroxide compounds exert a bleaching effect during the laundering process via release of hydrogen peroxide upon contact with water. This effect may be enhanced in the presence of bleaching activators such as sodium-nonaolyloxy benzene sulfonate (NOBS), tetraacetyl ethylene diamine (TAED) and the like. These bleaching systems are often used in granule detergent compositions, the hydrogen peroxide source being agents such as sodium percarbonate and perborate. Such systems, however, suffer from the problem of being unstable over time when mixed with many detergent products.

Another issue is that the efficiency of the bleaching systems in the wash is reduced by the presence of the enzyme catalase in soiled laundry. Catalase is extremely efficient at degrading hydrogen peroxide and even the minute quantities present in laundry items as a result of contact with human skin can degrade a major part of the hydrogen peroxide used in wash systems. To overcome this problem, hydrogen peroxide sources such as sodium percarbonate are generally added in excess molar quantities—often several times the stoichiometric quantities needed for the reaction with the bleach activator. Thus, there is also a need for bleaching systems that effectively use bleaching raw materials, for example, hydrogen peroxide sources.

One way to minimize the issue of degradation of hydrogen peroxide by catalase is to closely co-locate the bleach activator and the peroxide source, e.g. percarbonate. Combining commonly used bleach activators with alkaline percarbonate is problematic, however, due to the fact that these bleach activators (TAED and NOBS) tend to degrade in alkaline environments. Thus, closely combining these bleach activators with alkaline percarbonate generally causes degradation of the bleach activator on storage. Attempts have been made to create particles comprising percarbonate and bleach activator to increase stability these systems using binders and other additives which coat the source of hydrogen peroxide. (See, e.g., WO 2007/127641, published also as US20070252107A1.) However, such approaches either cannot be conveniently used in a continuous process, and/or do not provide particles having suitable release profiles and/or do not have sufficient stability on storage.

Accordingly, there is a need for particles comprising hydrogen peroxide bleaching systems and optionally bleach activators that have good storage stability, suitable solubility in laundering processes, and/or improved hydrogen peroxide source use efficiency. The instant disclosure addresses one or more of the aforementioned needs.

### SUMMARY OF THE INVENTION

Layered particles, compositions comprising such particles as well as methods of making and using such particles and compositions, are disclosed. A method of improving the stability of a source of hydrogen peroxide is also disclosed.

### DETAILED DESCRIPTION OF THE INVENTION

As used herein, articles such as “a” and “an” when used in a claim, are understood to mean one or more of what is claimed or described.

As used herein, the term “additive” means a composition or material that may be used separately from (but including before, after, or simultaneously with) the detergent during a laundering process to impart a benefit to the treated textile.

As used herein, the term “core,” as applied to a source of hydrogen peroxide such as percarbonate, includes the active agent itself in addition to any coating applied by the manufacturer.

As used herein, the term “gelling agent” means a material capable of forming a gel upon contact with water.

“Gel” as defined herein refers to a transparent or translucent liquid having a viscosity of greater than about 2000 mPa*s at 25° C. and at a shear rate of 20 sec-¹. In some embodiments, the viscosity of the gel may be in the range of from about 3000 to about 10,000 mPa*s at 25° C. at a shear rate of 20 sec-¹ and greater than about 5000 mPa*s at 25° C. at a shear rate of 0.1 sec⁻¹.

As used herein, the terms “include”, “includes” and “including” are meant to be non-limiting.

As used herein, the term “layer” means a partial or complete coating of a layering material built up on a particle's surface or on a coating covering at least a portion of said surface.

As used herein, “particle size” refers to the diameter of the particle at its longest axis.

As used herein, the term “mean particle size” means the mid-point of the size distribution of the particles made herein, determined according to the methods disclosed herein.

As used herein, the term “solvent” is meant to connote a liquid portion that may be added to one or more components described herein. The term “solvent” is not intended to require that the solvent material be capable of actually dissolving all of the components to which it is added. Exemplary solvents include alkylene glycol mono lower alkyl ethers, propylene glycols, ethoxylated or propoxylated ethylene or propylene, glycerol esters, glycerol triacetate, lower molecular weight polyethylene glycols, lower molecular weight methyl esters and amides, and the like.

As used herein, “substantially free of” a component means that no amount of that component is deliberately incorporated into the composition.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Applicants recognized that it is possible to make a co-particle of a peroxide source, such as percarbonate, and bleach activator that overcomes one or more of the problems described above. The disclosed compositions comprise, in general, a layered particle where the TAED or other bleach activator is layered around a percarbonate (or other hydrogen peroxide source) particle to form a substantially continuous coating. Applicants recognized that the stability of the bleach activator in particular can be improved during storage by varying the ratio of the bleach activator to the percarbonate, with particle storage stability increasing as the ratio of bleach activator to percarbonate is increased. Without being bound by theory, the increase in storage stability is believed to be due to the thickening of the coating layer of bleach activator around the core particle arising from the increase in the activator portion. This in turn results in the proportion of the bleach activator in close contact with the surface of the percarbonate being reduced. In another aspect, the bleach activator may be diluted in the layering powder to form a thicker, but diluted layer, which will also reduce the proportion of bleach activator in close proximity with the surface of the bleach activator. Without being bound by theory, Applicants believe that the thicker the layer provided, the greater the barrier to moisture ingress to the percarbonate surface. Reduced moisture ingress, in turn, is believed to improve overall stability of the layered particle.

Applicants have further recognized that, by selecting the proper binder, layered particles comprising a source of hydrogen peroxide and a bleaching activator can be formed, such that the layered particles have improved storage stability and a favorable dissolution profile. In one aspect, the layered particles disclosed herein allow for the co-localization of bleach activators and the source of hydrogen peroxide, thus allowing for improved efficiency in addition to improved stability. In another aspect, the layered particles are impermeable or have decreased permeability to catalase under wash conditions.

In one aspect, a layered particle comprising a core and a layer, said core comprising a source of hydrogen peroxide and said layer comprising a binder and a bleach activator, wherein the weight ratio of said source of hydrogen peroxide to said bleach activator may be from about 5:1 to about 1.1:1, or from about 4:1 to about 1.5:1, or about 2:1 is disclosed.

The layered particle may comprise from 30% to 90% or from 40% to 80% or from 50% to 70% by weight of the layered particle of a source of hydrogen peroxide.

In one aspect, the layered particle may have an average diameter of at least 200 μm or of at least 400 μm or from about 600 μm to 2000 μm, or from about 800 μm to about 1000 μm. In one aspect, the layer may have a thickness of from about 25 μm to about 150 μm, or from about 40 μm to about 100 μm.

Binder—The binder may comprise, based on total layered particle weight, from about 2% to about 20%, or from about 4% to about 15%, or about 6% to about 10%, or from about 7% to about 8% of said layered particle. The binder may comprise, based on total layered particle weight, from about 0.001% to about 5%, or from about 0.5% to about 3%, or about 1% to about 2% water. In one aspect, the binder may be substantially free of water. In one aspect, the binder may be capable of absorbing from about 0.1% to about 20%, or from about 1% to about 15%, or from about 2% to about 10% water by weight of said binder over a relative humidity of 80% at 32° C. In one aspect, the binder may have a viscosity of from about 200 to about 20,000, or from about 500 to about 7,000, or from about 1,000 to about 2,000 centipoise at a shear rate of 25 sec⁻¹ at 25° C.

The binder may comprise, based on total binder weight, from about 40% to 100%, or about 50% to about 99% of a surfactant material selected from the group consisting of anionic surfactant, nonionic surfactant, and combinations thereof, more preferably alcohol ethoxylate and linear alkylbenzene sulfonate. In one aspect, the binder may comprise, based on total binder weight, from about 60% to about 100%, or about 70% to about 90%, of a non-surfactant material comprising a hydrocarbon material selected from the group consisting of fats, triglycerides, lipids, fatty acids, soft paraffin wax, and combinations thereof.

In one aspect, the binder may have a pH of from about 3 to about 9, or from about 5 to about 8, or about 7, as measured as a 10% solution in water. In one aspect, the binder may comprise a solvent.

The source of hydrogen peroxide may comprise a per-compound. The sources of hydrogen peroxide may include sodium perborate in mono-hydrate or tetra-hydrate form or mixtures thereof, sodium percarbonate, and combinations thereof. In one aspect, the source of hydrogen peroxide may be sodium percarbonate. The sodium percarbonate may be in the form of a coated percarbonate particle.

In one aspect, the bleach activator may comprise a material selected from the group consisting of tetraacetyl ethylene diamine; oxybenzene sulphonate bleach activators, such as nonanoyl oxybenzene sulphonate; caprolactam bleach activators; imide bleach activators, such as N-nonanoyl-N-methyl acetamide; decanoyloxybenzenecarboxylic acid; amido-derived bleach activator; benzoxazin-type activator; acyl lactam activator; and combinations thereof. In one aspect, the bleach activator may comprise nonanoyl oxybenzene sulphonate (NOBS), tetraacetyl ethylene diamine (TAED), decanoyloxybenzenecarboxylic acid (DOBA), and combinations thereof. In another aspect, the bleach activator may comprise tetraacetyl ethylene diamine.

In one aspect, the bleach activator may comprise an amido-derived bleach activators of the formulae:

R¹N(R⁵)C(O)R²C(O)L or R¹C(O)N(R⁵)R²C(O)L

wherein as used for these compounds R¹ may be an alkyl group containing from about 6 to about 12 carbon atoms, R² may be an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. In one aspect, the leaving group may be oxybenzenesulfonate. In one aspect, the bleach activators may comprise (6-octanamido-caproyl)oxybenzenesulfonate, (6-nonanamidocaproyl)oxybenzene-sulfonate, (6-decanamido-caproyl)oxybenzenesulfonate, and mixtures thereof.

In one aspect, the bleach activator may comprise a bleach activator of the benzoxazin-type and may comprise:

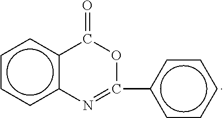

In one aspect, the bleach activator may be an acyl lactam activator of the formulae:

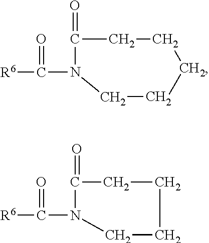

wherein as used for these compounds R⁶ may be H or an alkyl, aryl, alkoxyaryl, or alkaryl group containing from 1 to about 12 carbon atoms. In this aspect, the bleach activator may be acyl caprolactams and acyl valerolactams. In one aspect, the bleach activator may be selected from the group consisting of benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. Non-limiting examples of suitable bleach activators are disclosed in U.S. Pat. Nos. 4,915,854, 4,412,934, 4,634,551, 4,966,723, 4,545,784

In one aspect, the layered particle may comprise a dusting powder that may comprise a material selected from the group consisting of silicas; zeolites; amorphous aluminosilicates; clays; starches; celluloses; water soluble salts, such as an inorganic salt selected from the group consisting of, sodium chloride, sodium sulphate, magnesium sulphate, and salts and mixtures thereof; polysaccharides including sugars; and combinations thereof.

### Additives

The layer may comprise an additive selected from the group consisting of acidic materials, moisture sinks; gelling agents; antioxidants; organic catalysts and combinations thereof.

In one aspect, the additive may comprise an acidic material having a pKa of from about 3 to about 7, or about 5. In one aspect, the acidic material may be ascorbic acid.

In one aspect, the additive may comprise a moisture sink that may be selected from the group consisting of crosslinked polyacrylates; sodium salts of maleic/acrylic copolymers; magnesium sulfate; and combinations thereof.

In one aspect, the additive may comprise a gelling agent that may be selected from the group consisting of a cellulose including methylcellulose and CMC; alginate and derivatives thereof; starches; polyvinyl alcohols; polyethylene oxide; polyvinylpyrolidone; polysaccharides including chitosan and/or natural gums including carrageenan, xantham gum, guar gum, locust bean gum, and combinations thereof; polyacrylates including cross-linked polyacrylates; alcohol ethoxylates; lignosulfonates; surfactants and mixtures thereof; powdered anionic surfactants; and combinations thereof.

In one aspect, the additive may comprise an antioxidant that may be selected from the group consisting of phenolic antioxidants; amine antioxidants; alkylated phenols; hindered phenolic compounds; benzofuran or benzopyran; alpha-tocopherol, beta-tocopherol, gamma-tocopherol, delta-tocopherol, and derivatives thereof; 6-hydroxy-2,5,7,8-tetra-methylchroman-2-carboxylic acid; ascorbic acid and its salts; butylated hydroxy benzoic acids and their salts; gallic acid and its alkyl esters; uric acid and its salts and alkyl esters; sorbic acid and its salts; amines; sulfhydryl compounds; dihydroxy fumaric acid and its salts; and combinations thereof, 2,6-di-tert-butylphenol; 2,6-di-tert-butyl-4-methylphenol; mixtures of 2 and 3-tert-butyl-4-methoxyphenol; propyl gallate; tert-butylhydroquinone; benzoic acid derivatives such as methoxy benzoic acid; methylbenzoic acid; dichloro benzoic acid; dimethyl benzoic acid; 5-hydroxy-2,2,4,6,7-pentamethyl-2,3-dihydro-1-benzofuran-3-one; 5-hydroxy-3-methylene-2,2,4,6,7-pentamethyl-2,3-dihydro-benzofuran; 5-benzyloxy-3-hydroxymethyl-2,2,4,6,7-pentamethyl-2,3-dihydro-1-benzofura-n,3-hydroxymethyl-5-methoxy-2,2,4,6,7-pentamethyl-2,3-dihydro-1-benzofura-n; ascorbic acid; 1,2-dihydro-6-ethoxy-2,2,4-trimethylchinolin, and combinations thereof; 2,6-di-tert-butyl hydroxy toluene; alpha-tocopherol; hydroquinone, 2,2,4-trimethyl-1,2-dihydroquinoline; 2,6-di-tert-butyl hydroquinone; 2-tert-butyl hydroquinone; tert-butyl-hydroxy anisole; lignosulphonic acid and salts thereof; benzoic acid and derivatives thereof; trimethoxy benzoic acid; toluic acid; catechol; t-butyl catechol; benzylamine; amine alcohols; 1,1,3-tris(2-methyl-4-hydroxy-5-t-butylphenyl) butane; N-propyl-gallate or mixtures thereof; or di-tert-butyl hydroxy toluene.

In one aspect, the additive may comprise an organic catalyst that may be selected from the group consisting of iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones; and combinations thereof; or an organic catalyst selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl] isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfo oxy)propyl]isoquinolinium, inner salt; 2-[3-[(2-ethylhexyl)oxy]-2-(sulfooxy)propyl]-3,4-dihydroisoquinolinium, inner salt or mixtures thereof; or 2-[3-[(2-butyloctyl)oxy]-2-(sulfooxy)propyl]-3,4-dihydroisoquinolinium, inner salt.

In one aspect, the layered particle may be substantially free of fatty acids, fatty acid polyol esters, polyglycols, and fatty alcohol oxalkylates.

Composition—especially for shipment of the layered particles, the layered particle may be part of a composition. The composition may comprise at least 50%, or at least 60% or at from 70% to 95% or from 75% to 85% per weight of layered particles.

The composition may comprise additional particles, different from the layered particles and comprising in particular less than 20%, in particular less than 5%, for example between 0% and 2% of a source of hydrogen peroxide. The additional particles may have an average diameter smaller than the average diameter of the layered particle, preferably of at most 200 μm or of at most 150 μm or from about 2 μm to 100 μm, or from about 4 μm to about 60 μm. The composition may comprise from 5% to 40% by weight, for example from 10% to 30%, of additional particles. The additional particles may comprise salts, for example at least 50% or at least 80% per weight of salts. The salt may be a carbonate, a sulphate, a chloride, a bicarbonate, a citrate, an acetate, or mixture thereof. The additional particle may comprise bleach activator. The additional particles maybe prepared by grinding.

According to one aspect, the invention concerns a composition comprising from 50% to 95% of layered particles having a median particle size of from 600 μm to 2000 μm and from 5% to 40% of additional particles comprising less than 5% of a source of hydrogen peroxide and having a median particle sixe of from 2 μm to 200 μm.

The inventors have found that when the layered particles are shipped, the presence of additional smaller particles may help to preserve the physical integrity of the layered particles. This is in particular relevant when the layered particles are transferred through pneumatic transfer systems, the presence of additional smaller particles may avoid the smearing of the coating onto the insides of the pipes.

According to an exemplary embodiment of the invention, the invention concerns a composition comprising layered particles and a source of hydrogen peroxide which is not coated with bleach activator, such as percarbonate not coated with bleach activator. The invention may also concern a composition comprising layered particles having a different ratio of source of hydrogen peroxide to bleach activator. The invention concerns according to an exemplary embodiment, a process to prepare a composition comprising layered particles, comprising the step of mixing layered particles with components selected from source of hydrogen peroxide which are not coated with bleach activator, other layered particles having a substantially different ratio of source of hydrogen peroxide to bleach activator, and mixture thereof.

In the composition, the weight ratio of (the ratio of source of hydrogen peroxide to bleach activator in the layered particles) to (the ratio of source of hydrogen peroxide to bleach activator in the other layered particle) may be above 1.2, preferably above 1.5, or above 2 or between 2.5 and 4.5.

The inventors have found that it may be particularly advantageous to prepare detergent composition comprising source of hydrogen peroxide with different level of coating. This may allow a higher control on the rate of release of the hydrogen peroxide. This may be particularly advantageous when hydrogen peroxide needs to be released at different rate during a washing process.

The composition may comprise from 1% to 90%, or from 3% to 70% or from 5% to 50% or from 7% to 40% or from 10% to 30% per weight of layered particle. The detergent composition may comprise at least 1%, for example from 2% to 20% of from 3% to 10% per weight of a source of hydrogen peroxide which is not coated with bleach activator, such as percarbonate which is not coated with bleach activator.

### Method of Improving Stability of a Source of Hydrogen Peroxide

In another aspect, a method of improving the stability of a source of hydrogen peroxide, such as a percarbonate particle is disclosed. In this aspect, the method may comprise the step of providing a layer that may comprise a binder comprising a material selected from the group consisting of an anionic surfactants, nonionic surfactants, hydrocarbons including soft paraffin, and combinations thereof; or nonionic surfactants, anionic surfactants, and combinations thereof; or alcohol ethoxylate and linear alkylbenzene sulfonate; wherein said binder may comprise a viscosity of from about 200 to about 20,000, or from about 500 to about 7,000, or from about 1,000 to about 2,000 centipoise at a shear rate of 25 sec⁻¹ at 25° C.; wherein said binder may comprise from about 0.001% to about 5%, or from about 0.5% to about 3%, or about 1% to about 2% water, or is substantially free of water; wherein said layer substantially coats said source of hydrogen peroxide.

### Test Methods

Binder Component Viscosity Test—This test method must be used to determine binder component viscosity. Viscosity is determined using a Paar Physica UDS 200 using a Z3 cup and spindle at 25° C. in accordance with the manufacturer's instructions. As described in the method, a viscometer of type “A” is applicable to the range of viscosity cited in the current work.

Determination of Degree of Hygroscopicity—A petri dish having a diameter of 10 cm is weighed on a balance having four decimal places. 10 grams of test binder is added to the petri dish. The petri dish containing binder is then placed at 80% relative humidity at 32° C. for 24 hours. The petri dish containing binder is then weighed again. The degree of hygrosopicity is represented as % increase in weight of the binder, and is calculated as [(weight of binder_{final}−weight of binderᵢₙᵢₜᵢₐₗ)/10 g]1×100%.

Determination of Layer Thickness—Thickness of the layered particle layer may be determined by measuring the d50 of the core particle used prior to coating, and measuring d50 of the core particle after coating. The difference between these two measurements represents the thickness of the layer. Alternatively, SEM analysis can be used to measure the thickness of fractured particles.

Layering Powder Median Particle Size Test—This test method must be used to determine a layering powder's median particle size. The layering powder's particle size test is determined in accordance with ISO 8130-13, “Coating powders—Part 13: Particle size analysis by laser diffraction.” A suitable laser diffraction particle size analyzer with a dry-powder feeder can be obtained from Horiba Instruments Incorporated of Irvine, Calif., U.S.A.; Malvern Instruments Ltd of Worcestershire, UK; Sympatec GmbH of Clausthal-Zellerfeld, Germany; and Beckman-Coulter Incorporated of Fullerton, Calif., U.S.A.

The results are expressed in accordance with ISO 9276-1:1998, “Representation of results of particle size analysis—Part 1: Graphical Representation”, Figure A.4, “Cumulative distribution Q₃ plotted on graph paper with a logarithmic abscissa.” The median particle size is defined as the abscissa value at the point where the cumulative distribution (Q₃) is equal to 50 percent.

Determination of Median Particle Size—This test method must be used to determine seed material median particle size.

The particle size test is conducted to determine the median particle size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 um), #12 (1700 um), #16 (1180 um), #20 (850 um), #30 (600 um), #40 (425 um), #50 (300 um), #70 (212 um), #100 (150 um) is required. The prescribed Machine-Sieving Method is used with the above sieve nest. The particle of interest is used as the sample. A suitable sieve-shaking machine can be obtained from W. S. Tyler Company of Mentor, Ohio, U.S.A.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. The median particle size (D₅₀) is defined as the abscissa value at the point where the cumulative mass percent is equal to 50 percent, and is calculated by a straight line interpolation between the data points directly above (a50) and below (b50) the 50% value using the following equation:

D₅₀=10̂[Log(Dₐ₅₀)−(Log(Dₐ₅₀)−Log(D_{b50}))*(Qₐ₅₀−Q_{b50})]

where Qₐ₅₀ and Q_{b50} are the cumulative mass percentile values of the data immediately above and below the 50^{th} percentile, respectively; and Dₐ₅₀) and D_{b50} are the micron sieve size values corresponding to these data. In the event that the 50^{th} percentile value falls below the finest sieve size (150 um) or above the coarsest sieve size (2360 um), then additional sieves must be added to the nest following a geometric progression of not greater than 1.5, until the median falls between two measured sieve sizes.

### EXAMPLES

### Example I

Preparation of Propandiol Binder—72 grams of micronized sodium carbonate, d50 of 20 microns, is dispersed into 600 g of propanediol, available from VWR, using a high shear mixer for 1 min. The propanediol and carbonate mixture is transferred into the bowl of a Kenwood Chef kMixer. 400 g of HLAS, available from Sasol, (˜60° C.) is slowly added to the propanediol and carbonate with the mixer on at setting of 3-4 to avoid excessive foaming. After addition of HLAS, the mix is allowed to mix for 1 minute. The mix is then allowed to de-aerate in a 60° C. oven. Any unreacted carbonate at the bottom of the mix is separated off. The pH is then adjusted to between 4 to 10 by addition of carbonate or HLAS. The mix is then de-aerated as above, and any further unreacted carbonate is separated from the mix. The final pH of the mix is between 5 and 6.

### Example II

Preparation of Nonionic/LAS Binder—72 g micronized carbonate, d50 of 20 microns, is mixed into 600 g Neodol 45-7, available from Shell Chemicals, (nonionic surfactant) using a high shear mixer for 1 min. The nonionic/carbonate blend is transferred into the bowl of a Kenwood Chef kMixer. 400 grams of HLAS is slowly added into the nonionic/carbonate blend using continuous mixing for five minutes. 300 g of magnesium sulphate is added to the HLAS/nonionic/carbonate mixture and stirred for 10 minutes. The pH is then adjusted to between 4 to 10 by addition of either carbonate or HLAS. The mix is then de-aerated as above, and any further unreacted carbonate is separated from the mix. The final pH of the mix is between 5 and 6

### Example III

Preparation of Layered Particles—400 g of sodium percarbonate (Ecox-C™, available from Kemira, Finland) is mixed with 20.4 g of the propanediol binder in a Braun K 700 Food Processor until the mixture is visibly sticky. 200 g of TAED (Mykon™) Powder, available from Warwick International, Mostyn, Flintshire, U.K.) is then added. A further 12.3 g of the binder is then added with mixing. 30.5 g of carboxymethylcellulose, available under the tradename Finnfix® CMC, from CP Kelco is then added as a dusting agent to coat the particle.

### Example IV

Preparation of Layered Particles—400 g of sodium percarbonate (Ecox-C™, available from Kemira, Finland) is mixed with 24 g of the nonionic/LAS binder in a Braun K 700 Food Processor until the mixture is visibly sticky. 200 g of TAED (Mykon™ Powder, available from Warwick International, Mostyn, Flintshire, U.K.) is then added. A further 11 g of binder is then added with mixing. 30.5 g of carboxymethylcellulose, available under the tradename Finnfix® CMC, from CP Kelco is then added as a dusting agent to coat the particle.

### Example V

Preparation of Layered Particles—400 g of sodium percarbonate (Ecox-C™, available from Kemira, Finland) is mixed with 35 g of the nonionic/LAS binder in a Braun K 700 Food Processor until the mixture is visibly sticky. 30.5 g of carboxymethylcellulose, available under the tradename Finnfix® CMC, from CP Kelco is then added. 200 g of TAED Powder, (available from Warwick International, Mostyn, Flintshire, U.K.) is then added to make co-particles with a PC:TAED ratio of 2;1.

### Example VI

Preparation of Layered Particles—400 g of sodium percarbonate (Ecox-C™, available from Kemira, Finland) is mixed with 20 g of the nonionic/LAS binder in a Braun K 700 Food Processor until the mixture is visibly sticky. 30.5 g of carboxymethylcellulose, available under the tradename Finnfix® CMC, from CP Kelco is then added. 100 g of TAED Powder, (available from Warwick International, Mostyn, Flintshire, U.K.) is then added to make co-particles with a PC:TAED ratio of 4;1.

### Example VII

Preparation of a mixture of Layered Particles—100 g of the above particles of example V are mixed with 100 g of the particles of example VI to give a blend with an overall ratio of 3:1.

### Example VIII

Preparation of a composition comprising layered particle and uncoated percarbonate—200 g of Layered particles according to Example IV are mixed with 60 g of the sodium percarbonate (Ecox-C™, available from Kemira, Finland).

### Example IX

Preparation of a shipping composition comprising Layered Particles—80 g of Layered particles according to Example III are mixed with 20 g of ground sulphate having a d50 of 40 μm.

### Example X

Preparation of a shipping composition comprising Layered Particles—75 g of Layered particles according to Example III are mixed with 15 g of ground sulphate having a d50 of 40 μm and 10 g of the sodium percarbonate (Ecox-C™, available from Kemira, Finland).

### Example XI

Preparation of a shipping composition comprising Layered Particles—80 g of Layered particles according to Example III are mixed with 5 g of ground sulphate having a d50 of 40 μm and 10 g of fine sodium bicarbonate with a d50 of 50 microns.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A layered particle comprising a core and a layer, said core comprising a source of hydrogen peroxide and said layer comprising a binder and a bleach activator; wherein the weight ratio of said source of hydrogen peroxide to said bleach activator is from about 5:1 to about 1.1:1.

2. A layered particle according to claim 1, wherein said layered particle having a median particle size of from about 600 μm to 2000 μm.

3. A layered particle according to claim 1, wherein said layer having a thickness of from about 25 μm to about 150 μm.

4. A layered particle according to claim 1 wherein said binder comprises, based on total layered particle weight, from about 2% to about 20% of said layered particle.

5. A layered particle according to claim 1, wherein said binder comprises, based on total layered particle weight, from about 0.001% to about 5% water.

6. A layered particle according to claim 1 wherein said binder absorbs from about 0.1% to about 20% over a relative humidity of 80% at 32° C.

7. A layered particle according to claim 1 wherein said binder has a viscosity of from about 200 to about 20,000 centipoise at a shear rate of 25 sec⁻¹ at 25° C.

8. A layered particle according to claim 1 wherein said binder comprises, based on total binder weight, from about 40% to 100% of a surfactant material selected from the group consisting of anionic surfactant, nonionic surfactant, and combinations thereof.

9. A layered particle according to claim 1 wherein said binder comprises, based on total binder weight, from about 60% to about 100% of a non-surfactant material comprising a hydrocarbon material selected from the group consisting of fats, triglycerides, lipids, fatty acids, soft paraffin wax, and combinations thereof.

10. A layered particle according to claim 1 wherein said binder has, as measured as a 10% solution in water, a pH of from about 3 to about 9.

11. A layered particle according to claim 1 wherein said binder comprises a solvent.

12. A layered particle according to claim 1 said source of hydrogen peroxide comprising a per-compound.

13. A layered particle according to claim 1, said bleach activator comprising a material selected from the group consisting of tetraacetyl ethylene diamine; oxybenzene sulphonate bleach activators; caprolactam bleach activators; imide bleach activators; decanoyloxybenzenecarboxylic acid; amido-derived bleach activators; benzoxazin-type activators; acyl lactam activators; and combinations thereof.

14. A layered particle according to claim 1, said bleach activator comprising a material selected from the group consisting of sodium-nonaolyloxy benzene sulfonate (NOBS), tetraacetyl ethylene diamine, and combinations thereof.

15. A layered particle according to claim 1 comprising a dusting powder comprising a material selected from the group consisting of silicas; zeolites; amorphous aluminosilicates; clays; starches; celluloses; water soluble salts; polysaccharides including sugars; and combinations thereof.

16. A layered particle according to claim 15 wherein said additive comprises an acidic material having a pKa of from about 3 to about 7.

17. A layered particle according to claim 1, said layered particle being substantially free of fatty acids, fatty acid polyol esters, polyglycols, and fatty alcohol oxalkylates.

18. A composition comprising from 50% to 95% per weight of layered particles according to claim 2 and comprising more than 30% per weight of a source of hydrogen peroxide, and from 5% to 40% per weight of additional particles comprising less than 5% per weight of a source of hydrogen peroxide and having a median particle size of from about 2 μm to 200 μm.

19. A process to prepare a composition comprising layered particles according to claim 1, comprising the step of mixing layered particles according to claim 1 with components selected from source of hydrogen peroxide which is not coated with bleach activator, other layered particles according to claim 1 having a substantially different ratio of source of hydrogen peroxide to bleach activator, and mixture thereof.

20. A method of improving the stability of a source of hydrogen peroxide comprising providing a layer comprising a binder comprising a material selected from the group consisting of an anionic surfactants, nonionic surfactants, hydrocarbons including soft paraffin, and combinations thereof;
wherein said binder comprises a viscosity of from about 200 to about 20,000 at a shear rate of 25 sec⁻¹ at 25° C.; and
wherein said binder comprises from about 0.001% to about 5% water;
wherein said layer substantially coats said source of hydrogen peroxide.
